(19) United States
(12) Patent Application Publication
(10) Pub. No.: US 2002/0031068 A1
(43) Pub. Date: Mar. 14, 2002

(54) Method and apparatus for writing optical recording media

(75) Inventor: Petrus C.J. Hoeven, Eindhoven (NL)

Correspondence Address: Corporate Patent Counsel, U. S. Philips Corporation, 580 White Plains Road, Tarrytown, NY, 10591, US

(73) Assignee: U.S. Philips Corporation

(21) Appl. No.: 09/924,992

(22) Filed: Aug. 8, 2001

Related U.S. Application Data
(63) Continuation of application No. 09/202,891, filed on Dec. 22, 1998.
Application No. 09/202,891 is a 371 of international application No. PCT/IB98/00645, filed on Apr. 27, 1998.

(30) Foreign Application Priority Data
May 1, 1997 (EP) 97107241.8
Jul. 18, 1997 (EP) 97202257.8

(51) Int. Cl. G11B 7/125

(52) U.S. Cl. 369/47.53

(57) ABSTRACT

A method is described for setting an optimum write power for recording information on an optical recording medium. A series of test patterns (20′, 21′, 22′) is written on the medium, the test patterns being written with different write powers. The values of the write power in subsequent test patterns form a symmetrical pattern. On reading the test patterns, the modulation of each read signal is determined. An optimum value of the write power is determined from the modulations.

The invention relates to an optical recording apparatus for writing information on an optical recording medium by a radiation beam, and in particular to a method for setting a write parameter of the radiation beam at an optimum value, comprising the step of writing at least one series of test patterns on the recording medium, the test patterns having various values of the write parameter, the step of reading the series of test patterns to form a read signal, the step of deriving values of a read parameter from the read signal for each test pattern, the step of determining the optimum value of the write parameter in dependence on the values of the read parameter. The invention further relates to an apparatus for writing information on a disc-shaped optical recording medium adapted for carrying out the method for setting a write parameter to an optimum value.

A recording method according to the preamble is known from the U.S. Pat. No. 5,185,733. The method determines the optimum value of the write power of the radiation beam. It writes a series of test patterns on the medium, each subsequent test pattern being written with an increased write power level. After reading the written test patterns, an optimum value of the write power is derived from the amplitudes of the read signal of each test pattern. A disadvantage of this known method is that it does not always provide the optimum write power level for any combination of apparatus and recording media. Hence, use of the write power level as determined by the known method may cause unreliable storage of information on the recording medium.

It is an object of the invention to provide a more reliable method for setting the optimum value of a write parameter in dependence on read signals from test patterns written on a medium.

This object is achieved when the method of the preamble is characterized in that the values of the write parameter in subsequent test patterns form a symmetrical pattern.

The read parameters are often time-averages of the read signal, obtained by filtering the read signal. The delay inherent to filters causes inaccuracies in the measurement of the read parameters, which inaccuracies increase with decreasing measurement time. The effect of the delays can be mitigated when the values of the write parameter of subsequent test patterns in a series form a symmetrical pattern.

A pattern is called symmetrical if the values of the write parameter in a first half of the series are substantially the same as in a second half of the series, the values in the first and second halves being mirror-symmetrical. Symmetrically located test patterns in a series thus have the same write parameter. Symmetrically located test patterns have preferably equal lengths on the recording medium. The lengths of the different patterns in a series may be different, but they are preferably chosen equal to simplify the processing of the read signal. The symmetrical pattern may be a pattern in which the write parameter in a series increases stepwise from a lower limit to an upper limit of the range and subsequently decreases with the same steps to the lower limit. Alternatively, the steps may be from the upper limit to the lower limit and subsequently back to the upper limit. The steps in a series need not be equal. A pattern may have smaller steps in the middle of the range and larger steps near the limits of the range.

When reading a test pattern, the value of a read parameter will not have reached its final value at the end of the test pattern because of the delay in filtering of the read signal. When the value of the read signal from a test pattern in the first half of the series approaches the final value from below, then the signal from the symmetrically located test pattern in the second half will approach the final value from above, or vice versa. When the values of the read parameter of these two test patterns, as determined at the end of the test pattern, are averaged, a better estimate of the final value is obtained. The averaging at least partially cancels the effect of the filter delay. The averaging may also be performed on a value of the write parameter derived from the measured read parameters.

The inventive method causes the determination of the optimum value of a write parameter to be less dependent on delays in the recording apparatus. This independence of the delays is important for recording apparatuses which can write at various speeds. Consequently, the delay of each filter need not be changed but can be maintained at one value, independent of the write speed.

The read parameter may be a modulation, a maximum amplitude or minimum amplitude of the read signal. It may also be a jitter value derived from the read signal. The write parameter may be a write or erase power of the radiation beam. For write methods using a pulse sequence to write a mark in the recording medium it may also be a pulse width of a first, intermediate or last pulse of the sequence, or the duration of the low-radiation power period preceding, during or trailing the sequence. The write parameter may also be the absorption of the radiation in the recording medium. The absorption may be determined from a measurement of the reflection of the radiation beam from the recording medium during writing, integrated over the duration of the radiation pulse.

In many applications, a single series of test patterns according to the invention written on a recording media suffice to derive a reliable value of the write parameter. However, disc-shaped recording media sometimes show variations in the recording sensitivity as a function of the angular position on the medium. These variations may be due to variations of the sensitivity of the recording material of the medium or warp of the medium. The variations may also be caused by the interaction between the recording apparatus and the medium, for instance by a not-perfect support of the medium on the turntable of the apparatus, causing skew of the medium. Warp and skew result in an angular-position-dependent aberration of the spot formed by the radiation beam in the medium, affecting the write performance of the apparatus. If, for example, a test pattern is written in an area of low sensitivity of the medium, the known method will provide a value of the write power which is too high for most areas of the medium.

A special embodiment of the method according to the invention solves this problem by writing at least two essentially similar series of test patterns on the medium, substantially evenly distributed over a revolution of the medium. When the measurements on these series of test patterns are averaged, the resulting optimum value of the write parameter is suitable for reliably writing over the entire area of the medium. The effect of variations in the recording sensitivity is reduced considerably when the series of test patterns are distributed evenly over a revolution of the medium. The range of values over which the write parameter is varied within a series is preferably equal for the all series in order to perform similar tests at various locations of the medium. The range preferably comprises the optimum value of the write parameter. The range may be selected by reading the lower and upper limit of the range from the recording medium which is being recorded. Alternatively, the recording apparatus can write a series of test patterns covering a large range, and determine from this series a smaller range which is used when writing the at least two series of test patterns according to the invention.

A number of n series is evenly distributed over a revolution of the medium when the angular distance between the beginning or end of two series, neighbouring in angular distance, is substantially equal to 360°/n. Since the variations in the recording sensitivity show often one cycle per revolution of the medium, a test recording of two series per revolution provides a reliable value of the write parameter. A larger number of series of test patterns improves the averaging over the medium. However, the number of series should not become too large because of the accompanying increase in the amount of calculations involved in determining the write parameter. A preferred number of series per revolution is therefore three. This number provides a better averaging than with two series and keeps the amount of calculation within reasonable bounds. Moreover, for many types of recording media the three series can be written within one revolution, thereby reducing the amount of time necessary for writing and reading the test patterns.

The number of test patterns in a series should be large enough to determine the write parameter with an accuracy as required for the writing of information on the recording medium. The number of test patterns is preferably larger than 15.

A further aspect of the invention relates to the apparatus for writing information on the disc-shaped optical record carrier. The apparatus comprises according to the invention a radiation source for emitting a radiation beam, a source control unit for controlling a write parameter of the radiation beam, a test control unit for generating a number of at least two series of test patterns for being written on the recording medium, the series being substantially evenly distributed over one revolution of the recording medium, each test pattern having a different value of the write parameter, and the values in each of the at least two series lying within one predetermined range, an output of the test control unit being connected to an input of the source control unit, a read unit for reading test patterns and forming a corresponding read signal, and a processor operatively connected for deriving values of a read parameter from the read signal for each test pattern, for determining the optimum value of the write parameter in dependence on the values of the read parameter and forming a write control signal representing the optimum value, and for averaging parameter values derived from the at least two series, the write control signal being connected to an input of the source control unit.

The objects, features and advantages of the invention will be apparent from the following more particular description of preferred embodiments of the invention, as illustrated in the accompanying drawings.

FIG. 1 is a diagram of an optical recording apparatus according to the invention,

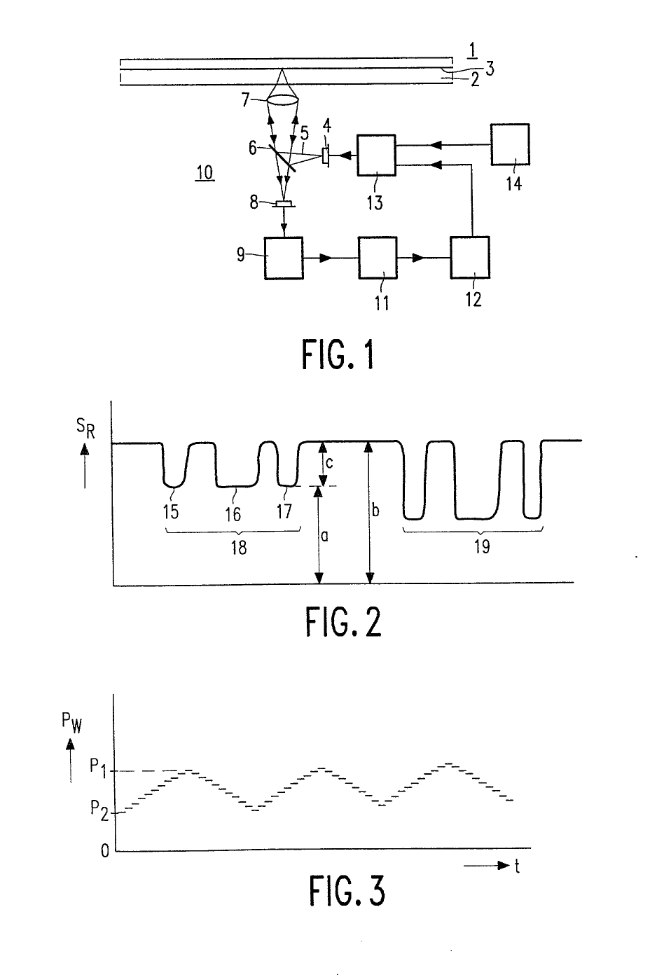

FIG. 2 illustrates a read signal from two test patterns,

FIG. 3 is a graph showing the variation of the write power over three series of test patterns,

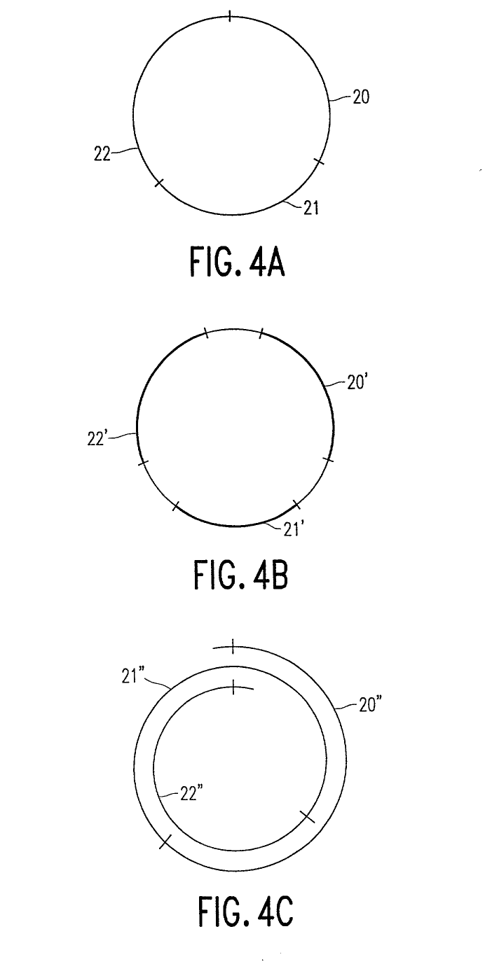

FIG. 4 shows the distribution of the written series of test patterns on the medium,

FIG. 5 shows part of a circuit for deriving a read parameter from a read signal,

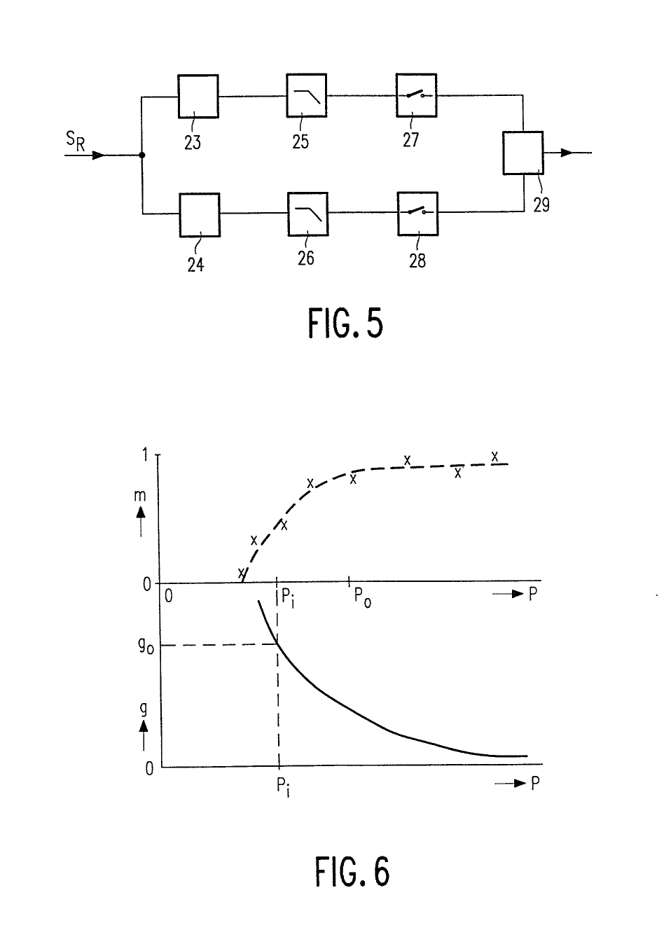

FIG. 6 is a graph showing the measured modulation and its derivative as a function of the write power,

FIG. 1 shows an optical recording apparatus and an optical recording medium 1. Medium 1 has a transparent substrate 2 and a recording layer 3 arranged on the substrate. The recording layer comprises a material suitable for writing information by means of a radiation beam. The recording may be of the magneto-optical type, the phase-change type, the dye type or any other suitable material. Information may be recorded on recording layer 3 in the form of optically detectable regions, also called marks. The apparatus comprises a radiation source 4, e.g. a semiconductor laser, for emitting a radiation beam 5. The radiation beam is converged on recording layer 3 via a beam splitter 6, an objective lens 7 and through substrate 2. The medium may also be air-incident, where the radiation beam is directly incident on recording layer 3 without passing through a substrate. Radiation reflected from medium 1 is converged by objective lens 7 and, after passing through beam splitter 6, falls on a detection system 8, which converts the incident radiation in electric detector signals. The detector signals are input to a circuit 9. The circuit derives several signals from the detector signals, such as a read signal S_{R} representing the information being read from medium 1. Radiation source 4, beam splitter 6, objective lens 7, detection system 8 and circuit 9 form together a read unit 10. The read signal from circuit 9 is processed in a first processor 11 in order to derive signals representing a read parameter from the read signal and necessary for controlling a write parameter, such as the laser power level. The derived signals are fed in a second processor 12, which processes a series of values of the read parameter and based thereon derives an optimum value of a write parameter and a write control signal representing the optimum value. Processors 11 and 12 may be integrated in a single processor. The write control signal is connected to an input of a source control unit 13. A pattern generator 14 generates the test patterns necessary for determining the optimum value of the write parameter. An output of pattern generator 14 is connected to an input of source control unit 13. Pattern generator 14 and second processor 12 may be connected to each other or integrated into a single unit for controlling the write parameter in dependence on the test patterns. When information is being written by the apparatus, an information signal representing the information to be written on medium 1 is fed into control unit 13. The output of control unit 13 is connected to radiation source 4 and controls at least the write parameter of the radiation beam output by source 4.

The actual radiation power emitted by radiation source 4 may be measured by a not-shown detector arranged in an otherwise not-used side lobe of the radiation beam or in radiation reflected off an element in the optical path of the radiation beam. The electrical signal of this detector may be connected to processor 12 as an input of the actual write power used for writing the test patterns. Alternatively, the signal may be connected to processor 11, where it may be combined with the peak amplitude of the read signal, which is a measure for the radiation power received at recording layer 3, and subsequently fed into processor 12.

The invention will now be explained with reference to the apparatus shown in FIG. 1 in which the write parameter is the write power level of the radiation beam, for which an optimum value is determined, and the read parameter is the modulation of the read signal measured from the written test patterns.

For a reliable recording of information on medium 1, the apparatus sets its write power to the optimum value by performing the following procedure. First pattern generator 14 generates three series of test patterns which are written on medium 1. The test patterns should be selected so as to give a desired read signal. If the read parameter to be derived from the read signal is the maximum modulation of the read signal, the test pattern should comprise marks sufficiently long to achieve a maximum modulation of the read signal. When the information is coded according to the so-called EFM modulation, the test patterns preferably comprises the long I₁₁ marks.

The test patterns are recorded at different write powers. The test patterns may be written anywhere on the medium. They may also be written in specially provided test areas on the medium.

FIG. 2 shows the read signals 18 and 19 obtained from two test patterns written at different write power levels. The test patterns comprise a short mark, a long mark and a short mark, as shown by the signal parts 15, 16 and 17, respectively in read signal 18 and 19. An actual test pattern may comprise from a few tens up to a few thousand marks of different or equal lengths. The lengths of the marks and the lengths of the spaces in between marks may be chosen at random or according to a preferred fixed pattern.

FIG. 3 shows the write power P_{W} as a function of time for three series of test patterns. Each horizontal line indicates a write power used for writing one test pattern. The write powers vary within a range from lower limit P₁ to upper limit P₂. The first series start with a test pattern written at power P₁. The subsequent test patterns are written at write powers increasing with equal steps between test patterns, until write power P₂ is reached. The same test patterns are written again at write powers decreasing with the same steps, until write power P₁ is reached. The triangular pattern of write powers forms one series of test patterns. The same series of test patterns is written three times, as shown in the Figure.

The duration of each series is chosen in dependence on the write speed and the length of one revolution of the medium. FIG. 4 shows several examples in which the series of test patterns may be distributed over one revolution of the recording medium. In FIG. 4A the three series have been written as areas 20, 21 and 22 consecutively along a track of the recording medium and have a total length equal to the length of a 360° track. FIG. 4B shows an alternative, in which the total length of the three series is shorter than the length of a track. The written series 20′, 21′ and 22′ are separated by intermediate areas. FIG. 4C shows an example in which the total length of the three series is larger than the length of a track. The three written series 20″, 21″ and 22″ have a total length of two tracks. In the three examples of FIG. 4 the series are evenly distributed over one revolution of the medium. This means that the test patterns at a certain write power are written at substantially 120° intervals. When the measurements on these three test patterns are averaged, a slow variation of properties of the medium along a track will also be averaged. If instead of three series only a single series were written on a recording medium showing spatial variation of the recording sensitivity, a write parameter derived from it might be based on a test pattern at an extreme value of the varying medium property. If information were written using this write parameter, the written information might be unreliable in those areas of the medium where the property has the opposite extreme value.

Although the examples in FIG. 4 show three evenly distributed series of test patterns, the number of series may equally be one, two, four, five or larger, written on one, two or more tracks, the choice depending on the expected variation of the recording sensitivity and the time and recording medium space available for testing. In the example of FIG. 3 each series comprises two times eleven test patterns. This number may be smaller or larger dependent on the size of the range P₁-P₂, the required accuracy of the optimum value to be derived from the test patterns and the algorithm used for the derivation. An accurate determination may require about fifty test patterns in a series.

The optimum value of the write parameter may be derived in various ways from the read signal obtained from reading the test patterns. Below a relatively accurate way is described to derive an optimum value of the write power from the read signal.

After the apparatus has written the three series of test patterns on medium 1, the tracks comprising the series are read by read unit 10. The output signals of detection system 8 are processed by circuit 9, which forms read signal S_{R}. Processor 11 derives from read signal S_{R} a read parameter used for finding the optimum write power. A suitable read parameter is the ratio of the lowest amplitude of the signal parts in a read signal, indicated by ‘a’ in FIG. 2, and the maximum value of the read signal ‘b’. A preferred read parameter is the normalised modulation being the ratio of the maximum peak-to-peak value of a read signal c=(b−a) and the maximum value ‘b’ of the read signal.

FIG. 5 shows a possible implementation of part of processor 11 for forming the read parameter. Read signal S_{R} is fed to two peak detectors 23 and 24, the first one detecting the lowest values of S_{R}, the second one detecting the highest values of S_{R}. The read signal may be high-pass filtered before the peak detectors to remove the DC contents of the read signal. Each peak detector is followed by a low-pass filter 25, 26 for averaging the output of the peak-detectors. A sample-and-hold circuit 27, 28 after each filter is controlled to pass the output of the filters to a calculating circuit 29 at that position in the read signal which corresponds to the end of a test pattern. When the length of the test pattern is relatively short, the output of the filter need not yet have reached its limiting value at the end of the test pattern. The effects of the inaccuracy of the values sampled at the output of the filters is mitigated by the averaging procedure described in the next paragraph. The output signals of circuits 27 and 28 represent the values ‘a’ and ‘b’, respectively. Calculating circuit 29 now calculates the value of the normalised modulation of the read signal (b−a)/b.

As an alternative to the circuit shown in FIG. 5, the circuit may determine the average amplitude ‘d’ of read signal S_{R}, the difference ‘e’ between the maximum amplitude and ‘d’ and the difference ‘f’ between ‘d’ and the minimum amplitude. The modulation is then calculated as (e+f)/(d+e). Alternatively, the modulation may be calculated as (e+f)/d. Processor 11 determines the maximum and minimum amplitude as shown in FIG. 5. The average amplitude ‘d’ is determined from the read signal by a low-pass filter without a peak detector. The maximum, minimum and average amplitude signal may be combined in a calculating circuit after each of the amplitude signals has been passed through a sample-and-hold circuit. Alternatively, the three amplitude signals may be combined by a calculating circuit, which is followed by a sample-and-hold circuit. The low-pass filters 25 and 26 may be omitted; a low-pass filter should then be arranged after the output of the calculating circuit.

After having read the test patterns of one series, processor 12 has obtained from processor 11 a series of pairs of values for the modulation of a test pattern and the write power belonging to that test pattern. The write powers may be taken from the value of the write power control signal during recording the test patterns, or from a measurement of the radiation power during the recording. Processor 12 combines and averages the value pairs from test patterns in the first and second half of the series written at the same write power. By averaging the modulation of a test pattern written in the first half of the series at increasing write power with the modulation of the corresponding test pattern written in the second half at decreasing write power, the effects of the filter delay are at least partially cancelled.

The effect of filter delays may be further reduced if the modulation code used for writing the test patterns is DC free. This avoids jumps of the average level of the read signal between test patterns.

Instead of averaging the modulation, it is also possible to average the maximum and minimum values ‘a’ and ‘b’ over the corresponding test patterns and subsequently calculate the modulation of the patter from the averaged maximum and minimum values.

If the test patterns written on the medium are relatively short in comparison with the accuracy of addressing on the medium, an offset in the addressing might cause the processor to assign a write power of a neighbouring test pattern to the modulation of a test pattern. Since the wrong assignment in the left half of a series is towards higher power values and in the right half towards lower power values or vice versa, a suitable averaging of the left and right halves of a series removes to first order the effects of the wrong assignments.

FIG. 6 shows schematically the result of the processing of the read signal from one series of test patterns. The crosses are measured values of the modulation m as a function of the write power P. The determination of an optimum value of the write power from the measured values of m and P is made by way of example via a procedure using curve-fitting and a normalised derivative. This procedure has been described in the not-prepublished European patent application no. 96203397.3, to which reference is made for more details of the procedure. As a first step in this procedure, processor 12 fits a curve through the measured modulation values in order to obtain an analytic expression for the variation of the modulation as a function of the write power. The curve is indicated in FIG. 6 by a dashed curve. The fitting may be done by the well-known least-squares fitting algorithm. A suitable set of functions for fitting is the set of the orthogonal Legendre polynomials up to the third order.

As a next step, processor 12 calculates analytically a normalised derivative ‘g’ of the modulation with respect to the write power P. The normalised derivative g(P) is equal to the function (dm/dP)P/m. The function g derived from the fitted modulation m in FIG. 6 is shown by the drawn curve.

Processor 12 derives an intermediate write power Pᵢ from the normalised derivative by taking the value of the write power P belonging to a preset value g₀, as indicated by the dashed lines in FIG. 6. The value of g₀ may be a value set by the manufacturer of the recording apparatus and stored in a memory of the apparatus, or it may be a value stored on the medium to be written and read prior to or during the procedure to set the optimum write power. As a next step, the value of the intermediate power Pᵢ is multiplied by a constant h larger than one, having as result the optimum value of the write power P₀ for the first series of test patterns.

The values of the preset value g₀ and the multiplication constant h are determined by the manufacturer of the medium or by the user during initialisation of the medium. The value of g₀ is set within a range from 0.5 to 2.0. For values higher than 2.0 the normalised derivative looses it predicting value, because the proximity of an asymptote causes the values of P related to g₀ to lie closely together on the write power axis. For values of g₀ lower than 0.5 the normalised derivative has a small slope, through which small errors in the value of the derivative result in a large spread of the values of P₁ associated with g₀. The multiplication constant h is set preferably within a range from 1.00 to 1.35. The optimum write power P₀, equal to (h Pᵢ), is in general set to a value near the write power where the modulation m starts saturating.

In a preferred method of setting g₀ and h, the optimum write power of a specific medium is determined by finding the write power giving the lowest jitter of the read signal for information written on the medium. The information is preferably random information. Next, the normalised derivative dm/dP (P/m) is determined from a written series of test patterns as described above. A value for Pᵢ is selected such that the associated value of g₀ lies within the above range, and where the normalised derivative is neither too flat nor too steep. The associated values of h, equal to P₀/Pᵢ, and g₀ can now be used for all media of this type and for all recording apparatuses.

The above procedure for deriving the optimum value of the write power from a series of test patterns is repeated for the next two series of test patterns written on the medium. The three optimum values are subsequently averaged, giving the averaged optimum value of the write power, to be used for writing information on all areas of the medium. Processor 12 sets the write control signal at a value representing the optimum value of the write power and feeds it to source control unit 13, which uses it for recording information.

Processor 12 may be provided with a check routine, which checks the optimum values for outliers, i.e. values which lie outside a range within which the values are expected to lie. Excessive values are often caused by incidental occurrences such as a stain on the medium reducing the power incident on information layer 3. The check routine removes the excessive values. A similar check routine may be used for removing excessive values of the measured modulation of the test patterns.

Instead of using curve fitting, the derivative may also be determined from the modulation values by using a difference method as disclosed in European patent application no. 0 762 399.

The averaging over the three series in the above method is performed on the optimum values of the write parameter. It is also possible to combine the averaging over the right and left halves of each series and the averaging over the three series by averaging the values of the amplitudes ‘a’ and ‘b’ over the corresponding test patterns of the left halves and right halves of the three series. The averaged values of ‘a’ and ‘b’ can then be used for calculating averaged values of the modulation, and a single graph like FIG. 6 is obtained for determining the optimum value of the write power. Alternatively, the modulation may be calculated for each test pattern of the three series and the modulations of the corresponding test patterns in the three series averaged.

In the above examples of the method according to the invention the read parameter used for determining the optimum value of the write parameter is the modulation of the read signal. Alternatively, the read parameter may be an asymmetry parameter β. The parameter β is defined as the ratio of the difference of the above-mentioned difference values ‘e’ and ‘f’ over the sum of the difference values. The value of β as a function of write power is in general a line with a positive slope, going from negative to positive values of β. The method according to the invention must set the write power to such a value that β becomes substantially equal to a predetermined value prescribed in a standard or recorded on the recording medium. Common predetermined values of β are 0 and +0.04. The apparatus may determine the parameter β by sampling the filtered values of the maximum, minimum and average amplitude of the read signal of a pattern, and subsequently calculate therefrom the values of the differences ‘e’ and ‘f’.

1. In an optical recording apparatus for writing information on an optical recording medium by a radiation beam, a method for setting a write parameter of the radiation beam at an optimum value, comprising
the step of writing at least one series of test patterns on the recording medium, the test patterns having various values of the write parameter,
the step of reading the series of test patterns to form a read signal,
the step of deriving values of a read parameter from the read signal for each test pattern,
the step of determining the optimum value of the write parameter in dependence on the values of the read parameter,
characterised in that the values of the write parameter in subsequent test patterns form a symmetrical pattern.

2. The method according to claim 1, wherein the symmetrical pattern has a triangular form.

3. The method according to claim 1, wherein the method comprises the step of averaging parameter values derived from test patterns symmetrically located in a series.

4. The method according to claim 1, wherein at least two series of test patterns are written on a disc-shaped recording medium, the series being substantially evenly distributed over one revolution of the recording medium, the values of the write parameter in each of the at least two series lying within one predetermined range, and including the step of averaging parameter values derived from the at least two series.

5. The method according to claim 4, wherein three series of test patterns are written.

6. The method according to claim 4, wherein the averaging is performed on the values of the read parameter.

7. The method according to claim 4, wherein the averaging is performed on the values of the write parameter determined in dependence on the values of the read parameter.

8. An apparatus for writing information on an optical recording medium, comprising
a radiation source for emitting a radiation beam,
a source control unit for controlling a write parameter of the radiation beam,
a test control unit for generating a series of test patterns for being written on the recording medium, the test patterns having different values of the write parameter, an output of the test control unit being connected to an input of the source control unit,
a read unit for reading test patterns and forming a corresponding read signal,
and a processor operatively connected for deriving values of a read parameter from the read signal for each test pattern, for determining the optimum value of the write parameter in dependence on the values of the read parameter and for forming a write control signal representing the optimum value,
the write control signal being connected to an input of the source control unit,
characterised in that the values of the write parameter in subsequent test patterns form a symmetrical pattern.
